(19) United States
(12) Patent Application Publication
(10) Pub. No.: US 2014/0114656 A1
(43) Pub. Date: Apr. 24, 2014

(54) ELECTRONIC DEVICE CAPABLE OF GENERATING TAG FILE FOR MEDIA FILE BASED ON SPEAKER RECOGNITION

(71) Applicant: HON HAI PRECISION INDUSTRY CO., LTD., New Taipei (TW)

(72) Inventor: HO-LEUNG CHEUNG, Santa Clara, CA (US)

(73) Assignee: HON HAI PRECISION INDUSTRY CO., LTD., New Taipei (TW)

(21) Appl. No.: 14/014,418

(22) Filed: Aug. 30, 2013

(30) Foreign Application Priority Data
Oct. 19, 2012 (TW) 101138642

(51) Int. Cl. G10L 15/26

(52) U.S. Cl. CPC G10L 15/26
USPC 704/235

(57) ABSTRACT

An electronic device with speaker recognition function is provided. The electronic device includes a speaker recognition unit that can make a speaker recognition for a media file including speech content. Speakers of the speech content are thus determined. The processor of the electronic device determines the time durations when each of the speaker is speaking, and generates a tag file including the identities of the speakers and the time durations corresponding to each of the speakers. The tag file is associated with the media file.

### BACKGROUND

1. Technical Field

The present disclosure relates to an electronic device capable of generating a tag file for a media file based on speaker recognition.

2. Description of Related Art

With the increasing number of broadcasts, meeting recordings, and voice mail collected every year, there is a need to provide an electronic device and method for processing these contents to generating tag files based on speaker recognition, such that a user can search for a media file associated with a specific speaker based on the tag files.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic block diagram view of an electronic device according to one embodiment.

FIG. 2 is a schematic diagram view of a user interface of the electronic device of FIG. 1.

FIG. 3 is a flow chart of a method implemented by electronic device of FIG. 1.

### DETAILED DESCRIPTION

Embodiments of the present disclosure will be described with reference to the accompanying drawings.

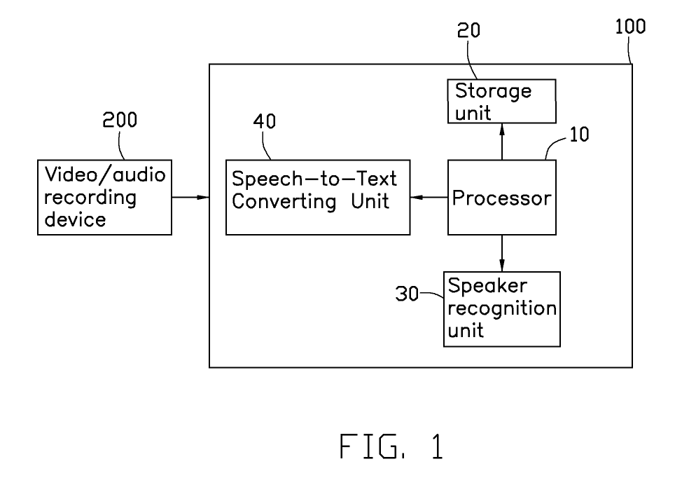

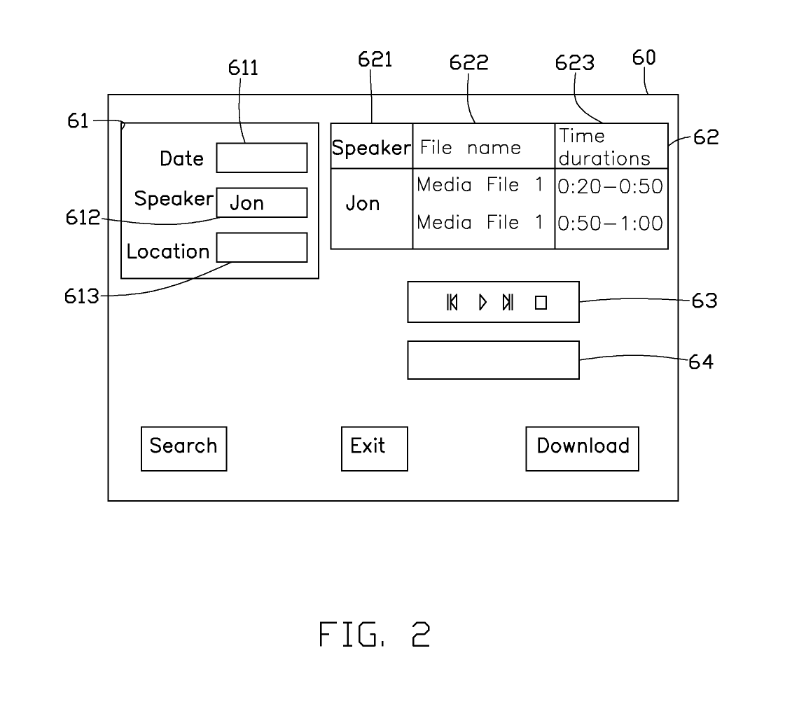

Referring to FIGS. 1 and 2, an electronic device 100 is provided to process media files (e.g., video files or audio files) including speech content and generate a searchable tag file for the media file. In the embodiment, the electronic device 100 serves as a remote server that a user can visit through a cell phone or a personal computer. The electronic device 100 can process a media file in response to a request from the user. The electronic device 100 may be connected with a video/audio recording device 200. Once the electronic device 100 has identified the video/audio recording device 200 connected thereto, the electronic device 100 is ready for processing media files from the video/audio recording device 200. The electronic device 100 will start to process media files once they are received from the video/audio recording device 200.

The electronic device 100 includes a processor 10, a storage unit 20, a speaker recognition unit 30, and a speech-to-text converting unit 40. The storage unit 20 stores a number of acoustic models. The speaker recognition unit 30 extracts acoustic features from speech content of a media file from the video/audio recording device 200 or other devices. The speaker recognition unit 30 compares each extracted acoustic feature with the acoustic models of the storage unit 30 to determine identities of speakers.

In the embodiment, the speaker recognition unit 30 divides the media file into a number of segments with the same length of time. The length of time of each segment is sufficiently small, such that each segment of the media file includes speech content of only one speaker. The speaker recognition unit 30 extracts an acoustic feature from the speech content of each segment, and compares the extracted acoustic feature with the acoustic models of the storage unit 30. If the extracted acoustic feature matches one of the acoustic models, the identity of one speaker is determined. The identities of all the speakers whose speech content is included in the media file are thus determined.

The processor 10 records a relationship between each segment and the identity of the speaker corresponding thereto, and can thus determine one or more time durations when each speaker is speaking. For example, for a test audio file having a time duration of 110 seconds, the speaker recognition unit 30 may divide the test audio file into 11 segments, each of which has a length of time of 10 seconds. The speaker recognition unit 30 makes a speaker recognition for each of the segments, and determines that the speech content of segments A, B, C, E, and F corresponds to speaker Jon, the speech content of segment D corresponds to speaker Bran, the speech content of segments G and H corresponds to speaker Tommen, and the speech content of segments I, J, and K corresponds to speaker Arya. The processor 10 can then determine the time durations when each of the speakers Jon, Bran, Tommen, and Arya is speaking. It is noted that the number of the segments can be varied according to need.

TABLE I
Relationship between speakers, segments, and time durations

| Speakers | Segments | Time Durations (seconds) |
|---|---|---|
| Jon | A, B, C | 0-30 |
| Bran | D | 30-40 |
| Jon | E, F | 40-60 |
| Tommen | G, H | 60-80 |
| Arya | I, J, K | 80-110 |

The processor 10 generates a tag file including the identities of speakers and the time durations, and associates the tag file with the media file. In one embodiment, the processor 10 may insert a hyperlink into the tag file that points to the media file. The tag file is stored on the storage unit 20, and is accessible by the user. When a user clicks on the hyperlink, he/she will be directed to the media file. The tag file is editable, and a user is allowed to insert other information, such as a location where the media file is recorded and the date when the media file is recorded.

The speech-to-text converting unit 40 converts the speech content of each of the segments of the media file into text. The processor 10 can then determine the text corresponding to each speaker. In one embodiment, the tag file may include the text corresponding to each speaker.

Referring to FIG. 2, in one embodiment, the electronic device 100 provides a user interface 60. The user interface 60 includes several query input fields 611, 612, and 613. A user can enter keywords in these fields to initiate a search. The processor 10 then searches for tag file(s) related to the keywords. The search results are displayed on a search result area 62 that includes a column 621 for showing speaker identity, a column 622 for showing media file name, and a column 623 for showing time durations corresponding to the speaker.

The displayed time durations are clickable, and the processor 10 plays the corresponding portion of the corresponding media file when a time duration is clicked. For example, the processor 10 plays media file 2, from 50 minutes to 1 hour, when the time duration “0:50-1:00” is clicked. The user interface 60 may include playback control buttons 623 to control the playback the media files. The user interface 60 further includes text displaying field 64 for displaying text corresponding to the playing media files.

In the embodiment, the user interface 60 further includes a download button. A user can select some content in the search result area 62 and then clicks the download button. The processor 10 creates a single file including the selected content. For example, the user may select “0:20-0:50” portion of media file 1 and “0:50-1:00” portion of media file 2, and the processor 10 creates a single file including “0:20-0:50” portion of media file 1 and “0:50-1:00” portion of media file 2.

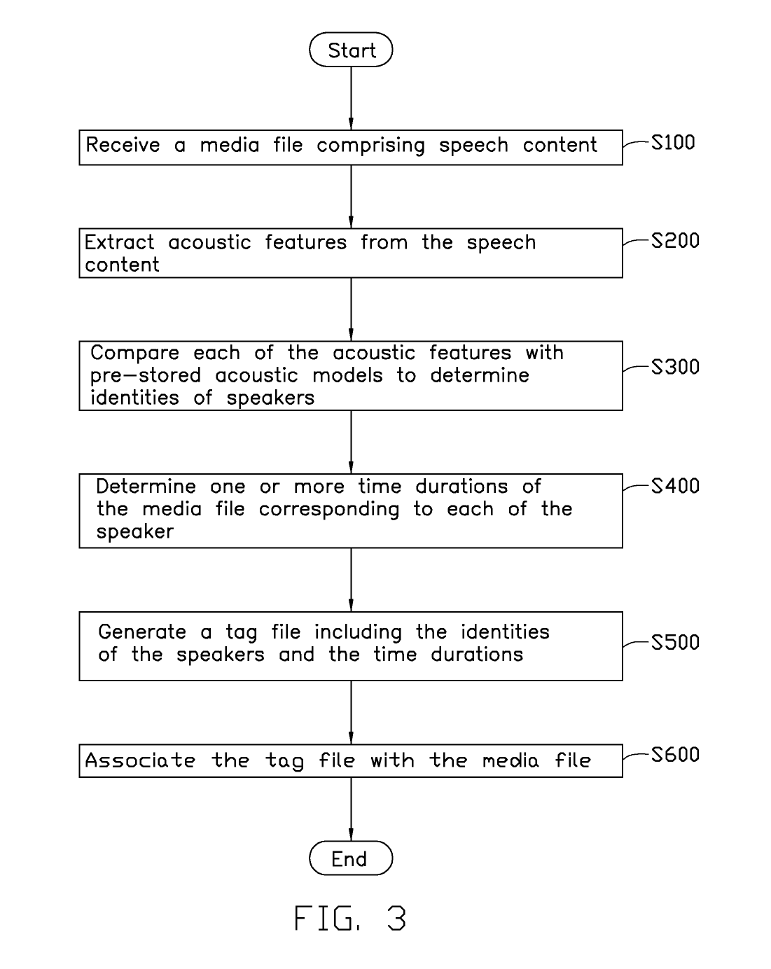

FIG. 3 shows a flow chart of a method implemented by the electronic device 100 according to one embodiment. In step S100, the electronic device 100 receives a media file including speech content. In step S200, the speaker recognition unit 30 extracts acoustic features from the speech content. In step S300, the speaker recognition unit 30 compares each of the acoustic features with pre-stored acoustic models to determine identities of speakers. In step S400, the processor 10 determines one or more time durations of the media file corresponding to each of the speaker. In step S500, the processor generates a tag file including the identities of the speakers and the time durations. In step S600, the processor 10 associates the tag file with the media file.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. An electronic device for generating tag files based on speaker recognition function, comprising:
a storage unit to store acoustic models;
a speaker recognition unit to extract acoustic features from speech content of a media file, and compare the extracted acoustic features with the acoustic models to determine identities of a group of speakers; and
a processor to determine one or more time durations when each of the speakers is speaking, the processor being further configured to generate a tag file that comprises the time durations and identities of the speakers corresponding to the time durations, the processor being further configured to associate the tag file with the media file, allowing a user to conduct a search to find the media file by using any of the identities as a keyword.

2. The electronic device according to claim 1, wherein the speaker recognition unit is configured to divide the media file into a plurality of segments, and make a speech recognition for each of the plurality of segments to determine the identity of one speaker corresponding to each of the plurality of segments.

3. The electronic device according to claim 2, further comprising a speech-to-text converting unit to convert speech of each of the plurality of segments into text, wherein the processor is further configured to insert text corresponding to each of the identities into the tag file.

4. The electronic device according to claim 1, wherein the tag file comprises a hyperlink that points to the media file, thereby associating the tag file with the media file.

5. The electronic device according to claim 1, further comprising a user interface to input query for searching for one or more media files corresponding to one of the speakers.

6. The electronic device according to claim 5, wherein the user interface comprises a search result area for displaying one or more time durations corresponding to the one of the speakers, and the processor plays a portion of one of the one or more media files, corresponding to one of the one or more time durations, when the one of the one or more time durations is clicked.

7. A method for generating a tag file for a media file based on speaker recognition, comprising:
receiving a media file comprising speech content;
extracting acoustic features from the speech content;
comparing each of the acoustic features with pre-stored acoustic models to determine identities of speakers;
determining one or more time durations of the media file corresponding to each of the speaker;
generating a tag file comprising the speakers and the time durations; and
associating the tag file with the media file.
